(19) United States
(12) Patent Application Publication
(10) Pub. No.: US 2014/0216156 A1
(43) Pub. Date: Aug. 7, 2014

(54) ACCELERATION SENSOR

(71) Applicant: DENSO CORPORATION, Kariya-city, Aichi-pref. (JP)

(72) Inventor: Minekazu Sakai, Kariya-city (JP)

(73) Assignee: DENSO CORPORATION, Kariya-city, Aichi-pref. (JP)

(21) Appl. No.: 14/238,942

(22) PCT Filed: Oct. 18, 2012
(86) PCT No.: PCT/JP2012/006654

§ 371 Date: Feb. 14, 2014

(30) Foreign Application Priority Data
Dec. 1, 2011 (JP) 2011-263918

(51) Int. Cl. G01P 15/125

(52) U.S. Cl. CPC G01P 15/125
USPC 73/514.32

(57) ABSTRACT

An acceleration sensor includes a first and second anchors above a substrate, a first weight portion supported by the first anchor, a first electrode extended from the first weight portion, a second electrode supported by the second anchor, and a first beam connecting the first weight portion with the first anchor. The first weight portion includes a first left portion and a first right portion with different weights. The first beam includes a first connection beam connecting the first left portion with the first anchor, and a first support beam connecting the first connection beam with the first anchor. When acceleration is applied to the acceleration sensor, the first left portion and the first right portion are movable in opposite directions in a seesaw manner, in which the first anchor-provides a support point.

### CROSS REFERENCE TO RELATED APPLICATIONS

The present disclosure is a U.S. national stage application of International Patent Application No. PCT/JP2012/006654 filed on Oct. 18, 2012 and is based on Japanese Patent Application No. 2011-263918 filed on Dec. 1, 2011, the disclosure of which is incorporated herein by reference.

### TECHNICAL FIELD

The present disclosure relates to a capacitance type acceleration sensor.

### BACKGROUND ART

Conventionally, as described in Patent document 1 for example, a MEMS device including a substrate, a first support portion, a second support portion, a first movable portion, and a second movable portion is disclosed. The first support portion and the second support portion are fixed to the substrate. The first movable portion is fixed to the first support portion so as to be movable in a z direction perpendicular to a main surface of the substrate. The second movable portion is fixed to the second support portion so as to be movable in the z direction. The first movable portion and the second movable portion are placed in an x direction along the main surface of the substrate, and movable in a z-x plane, in which the support portions provide support points. In the two movable portions, comb-shaped electrodes are formed. The comb-shaped electrode, which is formed in the first movable portion, and the comb-shaped electrode, which is formed in the second movable portion, are opposed in a y direction. The y direction is perpendicular to the x direction and to the z direction.

As described above, in the MEMS device described in Patent document 1, the two movable portions, providing the support points of the support portions, are movable in the z-x plane. The comb-shaped electrodes formed in the two movable portions are opposed along the y direction. According to the configuration, due to an application of acceleration or the like, when the movable portion moves in the z-x plane in a seesaw manner in which the support portion provides the support point, only an opposing area of the comb-shaped electrodes is mainly changed. Therefore, since a change of the capacitance of a capacitor formed by the comb-shaped electrodes mainly depends on the opposing area, a detection accuracy of the acceleration may not be enough.

### PRIOR ART DOCUMENT

### Patent Document

Patent Document 1: JP-A-2011-22137.

### SUMMARY OF THE INVENTION

It is an object of the present disclosure to provide an acceleration sensor with an improved detection accuracy of the acceleration.

In an aspect of the present disclosure, an acceleration sensor comprises a substrate having a main surface parallel to a x-y plane defined by an x direction and a y direction, the x direction being perpendicular to the y direction, a first anchor and a second anchor, which are disposed above the main surface of the substrate, a first weight portion supported by the first anchor, a first electrode extending from the first weight portion, a second electrode supported by the second anchor, and a first beam connecting between the first weight portion and the first anchor. The first weight portion includes a first left portion and a first right portion. The first left portion has different weight from the first right portion. The first left portion and the first right portion are arranged along the x direction. The first beam includes a first connection beam and a first support beam. The first connection beam extends along the x direction between the first left portion and the first right portion. The first connection beam connects the first left portion with the first right portion. The first support beam extends along the y direction between the first connection beam and the first anchor. The first support beam connects and supports the first connection beam and the first anchor. The first beam is configured that, when an acceleration is applied to the acceleration sensor in a z direction perpendicular to the x-y plane, the first left portion and the first right portion are movable in opposite directions each other in a z-x plane in a seesaw manner, in which the first anchor provides a support point. The z-x plane is defined by the z direction and the x direction. The first electrode and the second electrode are opposed along the x direction.

According to the above sensor, the first electrodes formed in each of the first left portion and the first right portion move in the opposite directions each other in the z-x plane in a seesaw manner, in which the first anchor provides the support point. The opposing area between the first electrode and the second electrode changes, and the opposing interval also changes. As describe above, since the opposing area and the opposing interval change due to the acceleration application, compared with a configuration that only the opposing area mainly changes due to the application of the acceleration, the change of the capacitance of the capacitor configured by the two electrodes increases. Accordingly, the detection accuracy of the acceleration is improved.

### BRIEF DESCRIPTION OF THE DRAWINGS

The above and other aspects, features and advantages of the present disclosure will become more apparent from the following detailed description made with reference to the accompanying drawings. In the drawings:

FIG. 1 is a top view illustrating a schematic configuration of an acceleration sensor according to a first embodiment;

FIG. 2 is a sectional view along line II-II in FIG. 1;

FIG. 3 is a sectional view illustrating a movement of a weight portion;

FIG. 4 is a sectional view illustrating a movement of the weight portion;

FIG. 5 is a top view illustrating a schematic configuration of the acceleration sensor according to a second embodiment;

FIG. 6 is a sectional view along line IV-IV in FIG. 5;

FIG. 7 is a sectional view illustrating a movement of the weight portion; and

FIG. 8 is a sectional view illustrating a movement of the weight portion.

### PREFERRED EMBODIMENTS FOR CARRYING OUT THE INVENTION

An embodiment of the present disclosure will be described with reference to the drawings below.

### First Embodiment

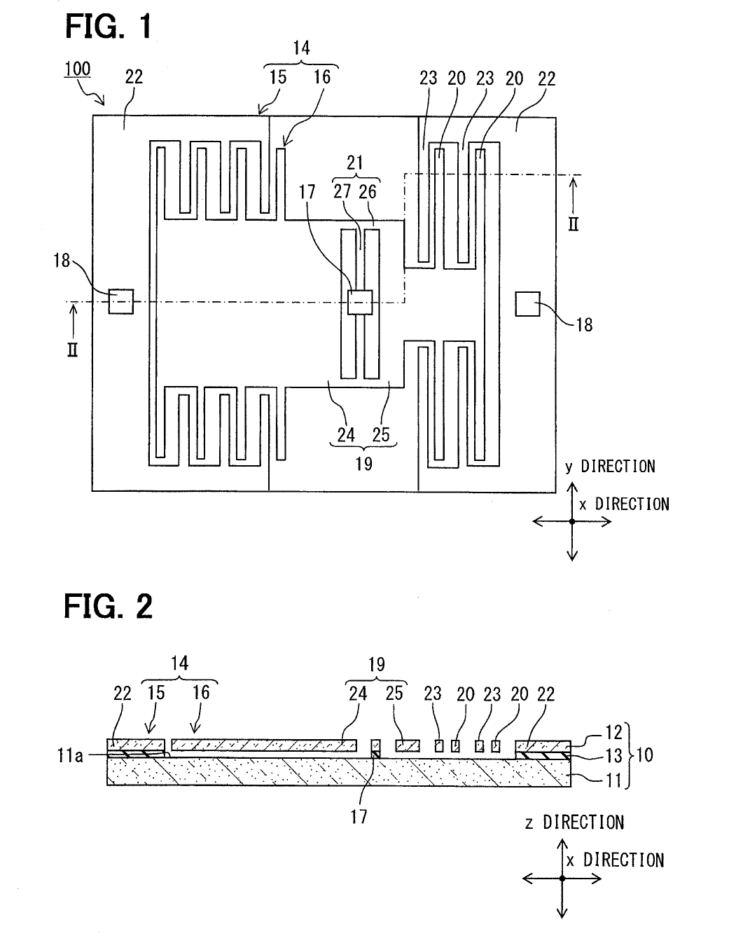

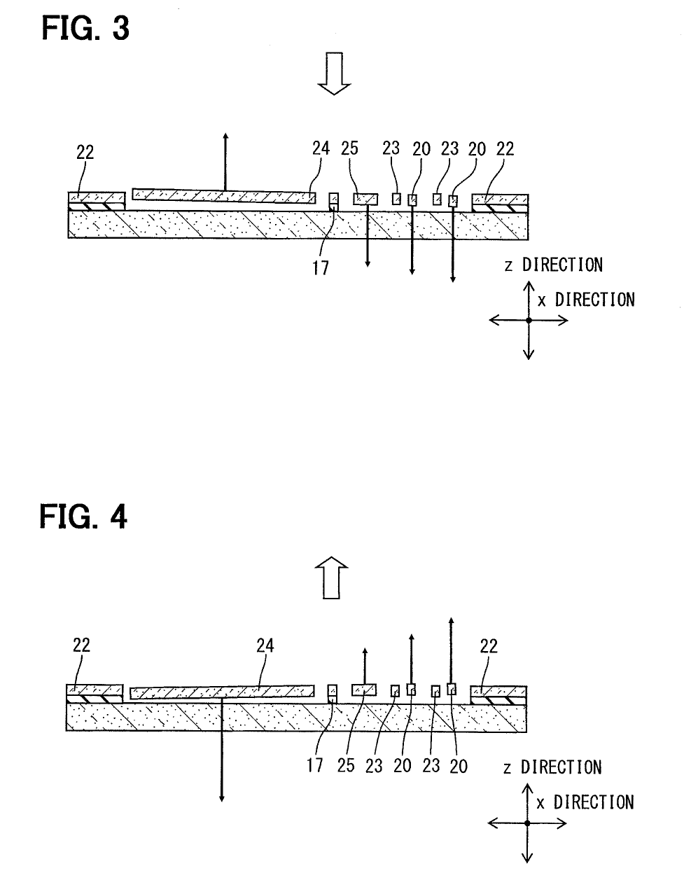

The acceleration sensor according to the present embodiment will be described based on FIG. 1 to FIG. 4. Incidentally, in FIG. 3 and FIG. 4, movement directions of a first weight portion and the first electrode are illustrated by a solid arrow, and symbols that are not required for a movement description are omitted. In addition, an x direction and a y direction, which are perpendicular to each other, are illustrated. A z direction perpendicular to the two directions is illustrated.

As described in FIG. 1 and FIG. 2, an acceleration sensor 100 is a product in which a microstructure is formed to a semiconductor substrate 10. The semiconductor substrate 10 is a SOI substrate in which an insulation layer 13 is placed between two semiconductor layers 11, 12. A main surface 11a of a first semiconductor layer 11 is placed along an x-y plane, which is defined by the x direction and the y direction. A sensor element 14 corresponding to the abode described microstructure is formed above the main surface 11a. The first semiconductor layer 11 corresponds to a substrate.

Using a well-known exposure technology, the sensor element 14 is formed by etching the second semiconductor layer 12 and the insulation layer 13 into a predetermined shape. The sensor element 14 has a fixed portion 15 where the second semiconductor layer 12 is fixed to the first semiconductor layer 11 through the insulation layer 13, and has a floating portion 16 that the second semiconductor layer 12 floats from the first semiconductor layer 11 without the insulation layer 13.

The fixed portion 15 has a first anchor 17 and a second anchor 18. The first anchor 17 and the second anchor 18 extend from the main surface 11a of the first semiconductor layer 11 along the z direction. The floating portion 16 has a first weight portion 19, a first electrode 20 that extends from the first weight portion 19, a first beam 21. The first beam 21 connects the first weight portion 19 and the first anchor 17. In the present embodiment, the fixed portion 15 has a second weight portion 22, which is integrally formed with the second anchor 18. The floating portion 16 has a second electrode 23 extending from the second weight portion 22.

The first weight portion 19 includes a first left portion 24 and a first right portion 25, which have different weights. As described in FIG. 1, the first left portion 24 has a plane rectangular shape. The first right portion 25 has a plane T shape. The first left portion 24 and the first right portion 25 are arranged along the x direction through the first anchor 17 and the first beam 21. The first left portion 24 is heavier than the first right portion 25. The first left portion 24 and the first right portion 25 are placed along the x direction, and are linearly symmetrical with a reference line going through the first anchor 17. In addition, the first electrode 20 extends along the y direction from a surface opposite to the second weight portion 22 in each of the first left portion 24 and the first right portion 25 to the y direction in a comb shape.

The first beam 21 has a first connection beam 26 and a first support beam 27. The first connection beam 26 connects the first left portion 24 and the first right portion 25. The first support beam 27 supports the first connection beam 26 and the first anchor 17. The first connection beam 26 extends from the first left portion 24 to the first right portion 25 in the x direction. The first support beam 27 extends from the first connection beam 26 to the first anchor 17 to the y direction. In the present embodiment, the first beam 21 has the two first connection beams 26 and the two first support beams 27. According to this configuration, a plane shape of the first beam 21 is an H shape. Incidentally, the first beam 21 is linearly symmetrical with the above reference line, similar to the first weight portion 19.

In the present embodiment, the fixed portion 15 has two second weight portions 22 that are arranged along the x direction through the first weight portion 19. Each of the two second weight portions 22 is a plane U shape. One of the second weight portions 22 surrounds a part of the first left portion 24, and the other of the second weight portion 22 surrounds a part of the first right portion 25. In addition, a second electrode 23 extends from a surface opposite to the first weight portion 19 in the second weight portion 22 in the y direction to the y direction in the comb shape. According to this configuration, the first electrode 20 and the second electrode 23 are engaged and opposed along the x direction, so that a capacitor is configured. A change in capacitance is detected as acceleration. Incidentally, each of the two second weight portions 22 is linearly symmetrical with the reference line. Each of the first anchor 17 connected to the first weight portion 19 and the second anchors 18 connected to the second weight portions 22 is arranged on the reference line. According to this configuration, the acceleration sensor 100 is linearly symmetrical with the reference line.

Based on FIG. 3 and FIG. 4, a movement of the first weight portion 19 will be described in a case where acceleration is applied to the acceleration sensor in the z direction. When the acceleration is applied to the acceleration sensor along the z direction, an inertial force is generated to each of the first left portion 24 and the first right portion 25. As described above, since the first left portion 24 is heavier than the first right portion 25, the inertial force generated in the first left portion 24 is larger than the inertial force generated in the first right portion 25. Thus, as described in an void arrow in FIG. 3, when the acceleration is applied to the acceleration sensor in a direction from the second semiconductor layer 12 to the first semiconductor layer 11, the first left portion 24 moves in a direction opposite to an acceleration application direction, and the first right portion 25 moves in a direction opposite to the first left portion 24. On the contrary, as described in the void arrow in FIG. 4, when the acceleration is applied to the acceleration sensor in a direction from the first semiconductor layer 11 to the second semiconductor layer 12, the first left portion 24 moves in a direction opposite to the acceleration application direction, and the first right portion 25 moves in a direction opposite to the first left portion 24.

Due to application of the acceleration along the z direction, the first left portion 24 and the first right portion 25 move in opposite directions each other, and a moment is generated around an axial direction in the y direction at a connection portion between the first connection beam 26 and the first support beam 27, so that the first connection beam 26 twists in the z direction. According to this twist, each of the first left portion 24 and the first right portion 25 moves in opposite directions each other in the z-x plane in a seesaw manner, in which a connection portion (the first anchor 17) between the first connection beam 26 and the first support beam 27 provides the support point. As a result, the first electrode 20 formed in each of the first left portion 24 and the first right portion 25 moves in the opposite directions each other in the z-x plane in a seesaw manner, in which the first anchor 17 provides the support point. The opposing area between the first electrode 20 and the second electrode 23 changes, and in addition, an opposing interval also changes. According to this configuration, the capacitance of the capacitor changes and the acceleration is detected.

A technical effect of the acceleration sensor 100 according to the present embodiment will be described. As described above, when the acceleration is applied to the acceleration sensor along the z direction, the first electrode 20 moves in the z-x plane in a seesaw manner, in which the first anchor 17 provides the support point. The opposing area between the first electrode 20 and the second electrode 23 changes, and the opposing interval also changes. According to this configuration, compared to a configuration in which only an opposing area mainly changes due to an application of the acceleration, a capacitance change of the capacitor provided by the two electrodes 20, 23 increases. Therefore, a detection accuracy of the acceleration is improved.

The first weight portion 19 and the first beam 21 are linearly symmetrical with the reference line. According to this configuration, due to application of the acceleration along the z direction, it is prevented that the first weight portion 19 moves in the y direction. Therefore, a deterioration of the detection accuracy of the acceleration is suppressed.

### Second Embodiment

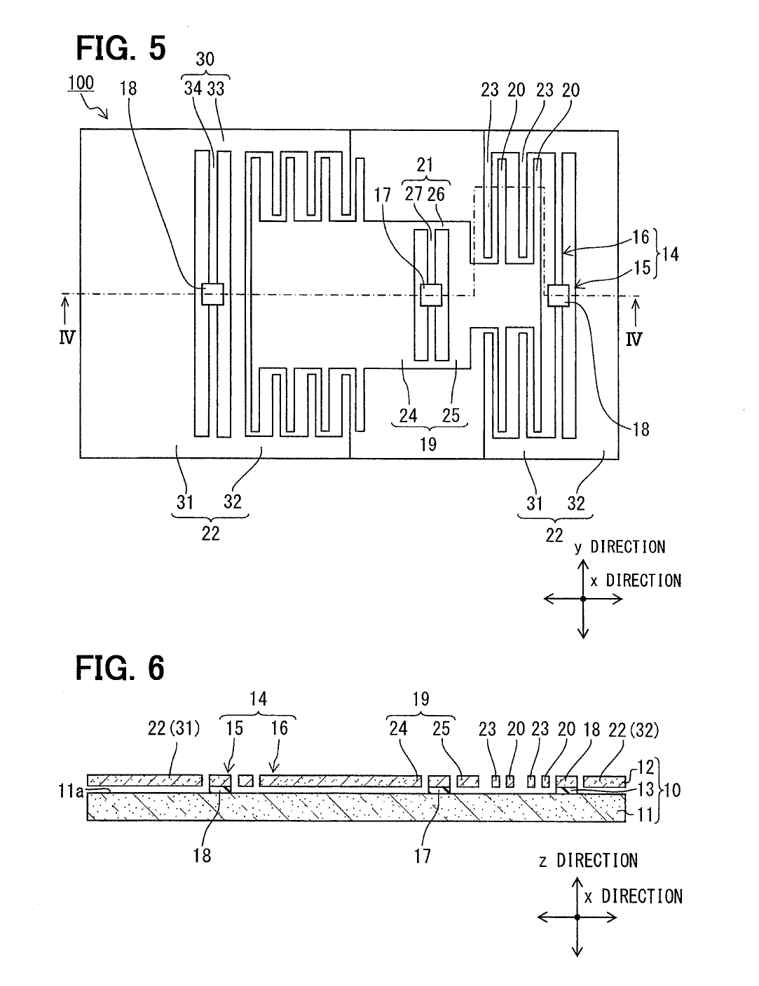

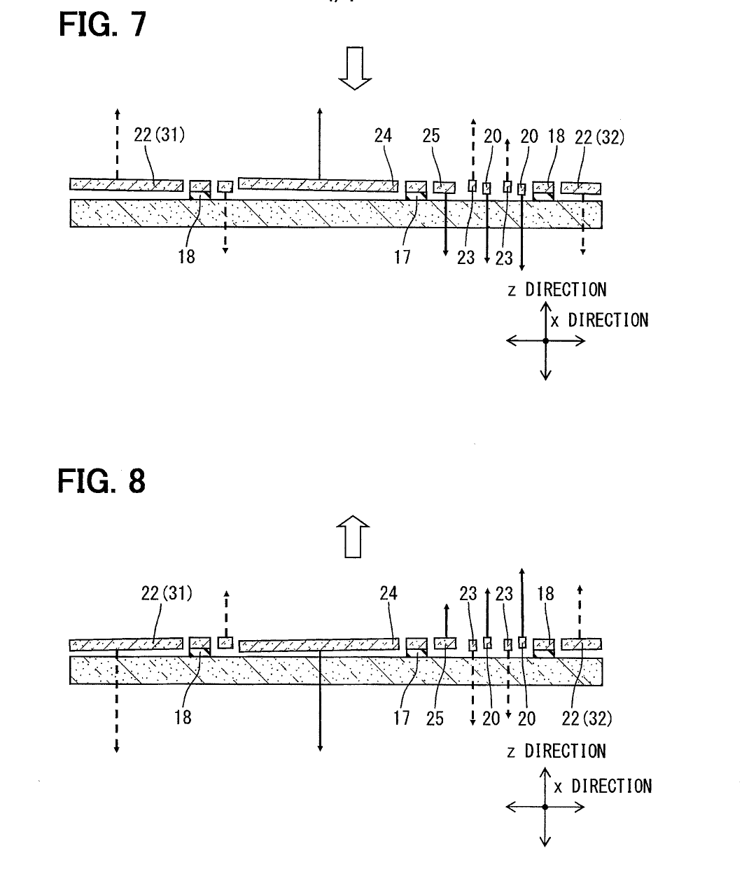

The second embodiment of the present disclosure will be described based on FIG. 5 to FIG. 8. Incidentally, in FIG. 7 and FIG. 8, a movement direction of the first weight portion and the first electrode is illustrated by the solid arrow. A movement direction of the second weight portion and the second electrode is illustrated by a dashed arrow. Symbols that are not required for a movement description are omitted.

The acceleration sensor 100 according to the second embodiment has many structures common to the first embodiment. Therefore, a description about common structures will be omitted, and a different part will be described intensively. Incidentally, elements identical with elements described in the first embodiment are given by identical symbols.

In the first embodiment, the second weight portion 22, in which the fixed portion 15 is integrally formed with the second anchor 18, is exemplified. On the contrary, in the present embodiment, different from the acceleration sensor 100 according to the first embodiment, the floating portion 16 has a second weight portion 22 and a second beam 30. The second beam 30 connects the second weight portion 22 with the second anchor 18. Therefore, as described in FIG. 6, the second weight portion 22 floats from the first semiconductor layer 11 without the insulation layer 13, and is movable with respect to the first semiconductor layer 11.

The second weight portion 22 includes a second left portion 31 and a second right portion 32. The second left portion 31 and the second right portion 32 have different weight, and are arranged along the x direction through the second anchor 18 and the second beam 30. In the present embodiment, the floating portion 16 includes the two second weight portions 22, which are arranged along the x direction through the first weight portion 19. As described in FIG. 5, the second left portion 31 of one of the second weight portion 22 and the second right portion of the other of the second weight portion 22 have a plane rectangular shape. On the contrary, the second right portion 32 of the one of the second weight portion 22 and the second left portion of the other of the second weight portion 22 have an oblong shape. A longitudinal direction of the two oblong shapes extends in the x direction, and each portion in the two oblong shapes is opposed in the y direction. Each of the two second weight portion 22 is in a plane U shape. The one of the second weight portion 22 surrounds a part of the first left portion 24. The other of the second weight portion 22 surrounds a part of the first right portion 25.

In each of the two second weight portions 22, the second right portion 32 of each of the second weight portions 22 is heavier than the second left portion 31 of each of the second weight portions 22. Each of the two second weight portions 22 is linearly symmetrical with the reference line. The second electrode 23 extends in the y direction from a face opposite to the first weight portion 19 in each of the second right portion 32 of the one of the second weight portion and the second left portion 31 of the other of the second weight portion 22 to the y direction.

The second beam 30 has a second connection beam 33 and a second support beam 34. The second connection beam 33 connects the second left portion 31 and the second right portion 32, and the second support beam 34 supports the second connection beam 33 and the second anchor 18. The second connection beam 33 extends from the second left portion 31 to the second right portion 32 in the x direction. The second support beam 34 extends from the second connection beam 33 to the second anchor 18 in the y direction. In the present embodiment, the second beam 30 has the two second connection beams 33 and the two second support beams 34. According to this configuration, a plane shape of the second beam 30 is in an H shape. Incidentally, the second beam 30, similar to the second weight portion 22, is linearly symmetrical with the reference line. According to this configuration, the acceleration sensor 100 is linearly symmetrical with the reference line.

Based on the FIG. 7 and FIG. 8, a movement of the second weight portion 22 will be described when the acceleration in the z direction is applied. Incidentally, although the first weight portion 19 also moves when the acceleration is applied to the acceleration sensor along the z direction, a movement basis has been described in the first embodiment, and therefore, a description will be omitted.

When the acceleration is applied to the acceleration sensor along the z direction, an inertial force is generated in each of the second left portion 31 and the second right portion 32, which configure the second weight portion 22. As described above, since the second left portion 31 in each of the two second weight portions 22 is heavier than the second right portion 32 in each of the two second weight portions 22, the inertial force generated in the second left portion 31 is larger than the inertial force generated in the second right portion 32. Therefore, as described by the void arrow in FIG. 7, when the acceleration is applied to the acceleration sensor in a direction from the second semiconductor layer 12 to the first semiconductor layer 11, the second left portion 31 moves in a direction opposite to the acceleration application direction, and the second right portion 32 moves in a direction opposite to the second left portion 31. On the contrary, as described by the void arrow in FIG. 8, when the acceleration is applied to the acceleration sensor in a direction from the first semiconductor layer 11 to the second semiconductor layer 12, the second left portion 31 moves in a direction opposite to the acceleration application direction, and the second right portion 32 moves in a direction opposite to the second left portion 31.

Due to application of the acceleration along the z direction, the second left portion 31 and the second right portion 32 move in opposite directions each other, and a moment is generated at the second connection beam 33 around an axial direction in the y direction at a connection portion between the second connection beam 33 and the second support beam 34, so that the second connection beam 33 twists in the z direction. According to this twist, each of the second left portion 31 and the second right portion 32 moves in opposite directions each other in the z-x plane in a seesaw manner, in which the connection portion (the second anchor 18) between the second connection beam 33 and the second support beam 34 provides a support point. As a result, the second electrode 23 formed in each of the second left portion 31 and the second right portion 32 moves in opposite directions each other in the z-x plane in a seesaw manner, in which the second anchor 18 provides the support point. The opposing area between the first electrode 20 and the second electrode 23 changes, and in addition, an opposing interval also changes.

Incidentally, when the acceleration is applied to the acceleration sensor in a direction from the second semiconductor layer 12 to the first semiconductor layer 11, the first left portion 24 of the first weight portion 19 moves in a direction opposite to the acceleration application direction, and the first right portion 25 moves in a direction opposite to the first left portion 24. On the contrary, the second left portion 31 moves in a direction opposite to the acceleration application direction, and the second right portion 32 moves in a direction opposite to the second left portion 31. As described above, the first left portion 24 and the second right portion 32 move in opposite directions each other, and the first right portion 25 and the second left portion 31 move in opposite directions. Therefore, movement directions of each of the first electrode 20 and the second electrode 23 are opposite.

When the acceleration is applied to the acceleration sensor in a direction from the first semiconductor layer 11 to the second semiconductor layer 12, the first left portion 24 moves in a direction opposite to the acceleration application direction, and the first right portion 25 moves in a direction opposite to the first left portion 24. On the contrary, the second left portion 31 moves in a direction opposite to the acceleration application direction, and the second right portion 32 moves in a direction opposite to the second left portion 31. As described above, in this case, the first left portion 24 and the second right portion 32 move in opposite directions, and the first right portion 25 and the second left portion 31 move in opposite directions. Therefore, the movement directions of each of the first electrode 20 and the second electrode 23 are opposite.

Technical effects of the acceleration sensor 100 according to the present embodiment will be described. As described above, when the acceleration is applied to the acceleration sensor along the z direction, the first electrode 20 moves in the z-x plane in the seesaw manner and in addition, the second electrode 23 also moves in the z-x plane in the seesaw manner. Accordingly, compared to a configuration in which only the first electrode moves in the z-x plane by the application of the acceleration along the z direction, the capacitance change of the capacitor configured by the two electrodes 20, 23 increases. Accordingly, the detection accuracy of the acceleration is improved.

The second weight portion 22 and the second beam 30 are linearly symmetrical with the reference line. According to this configuration, by applying the acceleration along the z direction, it is prevented that the second weight portion 22 moves along the y direction. Therefore, a deterioration of the detection accuracy of the acceleration is suppressed.

When the acceleration is applied to the acceleration sensor in the z direction, the first left portion 24 and the second right portion 32 move in the opposite directions. The first right portion 25 and the second left portion 31 move in the opposite directions. Accordingly, the movement directions of the first electrode 20 and the second electrode 23 are opposite each other. According to this configuration, compared with a configuration in which, when the acceleration is applied to the acceleration sensor along the z direction, a first electrode and a second electrode move to the same direction, the capacitance of the capacitor increases. Accordingly, the detection accuracy of the acceleration is improved.

As described above, although a preferable embodiment of the present disclosure is described, the present disclosure is not limited to the above described embodiment. It is possible to implement in various modified forms within a scope of the present disclosure.

In each of the embodiments, the opposing interval between the first electrode 20 and the second electrode 23, and a thickness of each of the electrodes 20, 23 along the z direction are not especially mentioned. However, it may be preferable that the opposing interval between the electrodes 20, 23 in a state where an external force is not applied is shorter than the thickness of each of the electrodes 20, 23. Although a detailed explanation is omitted, it is supposed that a displacement is represented by Δx, a predetermined opposing interval is represented by d, and the thickness is represented by h. In this condition, when the opposing interval between the electrodes 20, 23 is changed by Δx, the variation of the capacitance is proportional to Δx/(d−Δx). On the contrary, when a relative position of the electrodes 20, 23 is changed by Δx along the z direction, the variation of the capacitance is proportional to Δx/h. Thus, the opposing interval d is more effective to the variation of the capacitance than the thickness h. Therefore, it may be preferable that the opposing interval is shorter than the thickness of the electrodes 20, 23.

In the first embodiment, an example describes that the first left portion 24 is heavier than the first right portion 25. However, the first right portion 25 may be heavier than the first left portion 24.

In the first embodiment, an example describes that the first left portion 24 and the first right portion 25 are linearly symmetrical with the reference line. However, the first left portion 24 and the first right portion 25 may not be linearly symmetrical.

In the first embodiment, an example describes that the first beam 21 is linearly symmetrical with the reference line. However, the first beam 21 may not be linearly symmetrical.

In the first embodiment, an example describes that the fixed portion 15 includes the two second weight portion 22. However, it may be possible to employ a configuration that the fixed portion 15 includes one second weight portion 22.

In the second embodiment, an example describes that the second left portion 31 is heavier than the second right portion 32. However, it may be possible to employ a configuration that the second right portion 32 is heavier than the second left portion 31.

In the second embodiment, an example describes that the second left portion 31 and the second right portion 32 are linearly symmetrical with the reference line. However, the second left portion 31 and the second right portion 32 may not be linearly symmetrical.

In the second embodiment, an example describes that the second beam 30 is linearly symmetrical with the reference line. However, the second beam 30 may not be linearly symmetrical.

In the second embodiment, an example describes that the floating portion 16 has the two second weight portions 22. However, it may be possible to employ a configuration that the floating portion 16 has one second weight portion 22.

The above disclosure includes the following aspects.

According to the first aspect of the present disclosure, an acceleration sensor comprises a substrate having a main surface parallel to a x-y plane defined by an x direction and a y direction, the x direction being perpendicular to the y direction, a first anchor and a second anchor, which are disposed above the main surface of the substrate, a first weight portion supported by the first anchor, a first electrode extending from the first weight portion, a second electrode supported by the second anchor, and a first beam connecting between the first weight portion and the first anchor. The first weight portion includes a first left portion and a first right portion. The first left portion has different weight from the first right portion. The first left portion and the first right portion are arranged along the x direction. The first beam includes a first connection beam and a first support beam. The first connection beam extends along the x direction between the first left portion and the first right portion. The first connection beam connects the first left portion with the first right portion. The first support beam extends along the y direction between the first connection beam and the first anchor. The first support beam connects and supports the first connection beam and the first anchor. The first beam is configured that, when an acceleration is applied to the acceleration sensor in a z direction perpendicular to the x-y plane, the first left portion and the first right portion are movable in opposite directions each other in a z-x plane in a seesaw manner, in which the first anchor provides a support point. The z-x plane is defined by the z direction and the x direction. The first electrode and the second electrode are opposed along the x direction.

According to the above sensor, the first left portion and the first right portion have different weights. Therefore, for example, when the first left portion is heavier than the first right portion, and the acceleration is applied to the acceleration sensor along the z direction, the inertial force generated in the first left portion is larger than the inertial force generated in the first right portion. When the first left portion and the first right portion move in opposite directions each other due to the application of the acceleration along the z direction, a moment is generated at a first connection beam around an axial direction to the y direction at a connection portion between the first connection beam and the first support beam. The first connection beam twists in the z direction. According to this twist, each of the first left portion and the first right portion moves in opposite directions each other in a seesaw manner, in which the connection portion (a first anchor 17) between the first connection beam and the first support beam provides a support point. As a result, the first electrodes formed in each of the first left portion and the first right portion move in the opposite directions each other in the z-x plane in a seesaw manner, in which the first anchor provides the support point. The opposing area between the first electrode and the second electrode changes, and the opposing interval also changes. As describe above, since the opposing area and the opposing interval change due to the acceleration application, compared with a configuration that only the opposing area mainly changes due to the application of the acceleration, the change of the capacitance of the capacitor configured by the two electrodes increases. Accordingly, the detection accuracy of the acceleration is improved.

Alternatively, the first weight portion and the first beam may be linearly symmetrical with a reference line going through the first anchor. The reference line is parallel with the x direction. According to this configuration, it is prevented that the first weight portion moves in the y direction in the application of the acceleration in the z direction. Thus, a deterioration of the detection accuracy of the acceleration is suppressed.

Alternatively, the acceleration sensor may further include a second weight portion and a second beam connecting the second weight portion with the second anchor. The second electrode extends from the second weight portion. The second weight portion has a second left portion and a second right portion. The second left portion has different weight from the second right portion. The second left portion and the second right portion are arranged along the x direction. The second beam includes a second connection beam and a second support beam. The second connection beam extends along the x direction between the second left portion and the second right portion. The second connection beam connects the second left portion with the second right portion. The second support portion extends along the y direction between the second connection beam and the second anchor. The second support portion connects and supports the second connection beam and the second anchor. The second beam is configured that, when the acceleration is applied to the acceleration sensor in the z direction, the second left portion and the second right portion are movable in opposite directions each other in the z-x plane in the seesaw manner, in which the second anchor provides a support point. According to this configuration, the detection accuracy of the acceleration is improved.

Alternatively, the second weight portion and the second beam may be linearly symmetrical with the reference line going through the first anchor. The reference line is parallel with the x direction. According to this configuration, it is prevented that the second weight portion moves in the y direction in the application of the acceleration in the z direction. Thus, a deterioration of the detection accuracy of the acceleration is suppressed.

Alternatively, the first weight portion and the second weight portion may be arranged along the x direction, in which the first right portion is adjacent to the second left portion.

The first electrode is provided in the first right portion, and the second electrode is provided in the second left portion.

The first left portion is heavier than the first right portion and the second left portion is heavier than the second right portion, or the first left portion is lighter than the first right portion and the second left portion is lighter than the second right portion. According to this configuration, the detection accuracy of the acceleration is improved.

Alternatively, the second weight portion may include a second left weight portion and a second right weight portion. The second right portion of the second left weight portion and the first left portion of the first weight portion are adjacently arranged along the x direction. The second left portion of the second right weight portion and the first right portion of the first weight portion are adjacently arranged along the x direction. The second electrode is provided in the second right portion of the second left weight portion. The first electrode is provided in each of the first left portion and the first right portion. The second electrode is provided in the second left portion of the second right weight portion. The second left portion of the second left weight portion is heavier than the second right portion of the second left weight portion, the first left portion is heavier than the first right portion, and the second left portion of the second right weight portion is heavier than the second right portion of the second right weight portion, or the second left portion of the second left weight portion is lighter than the second right portion of the second left weight portion, the first left portion is lighter than the first right portion, and the second left portion of the second right weight portion is lighter than the second right portion of the second right weight portion. According to this configuration, the detection accuracy of the acceleration is improved.

Alternatively, an opposing interval along the x direction between the first electrode and the second electrode in a state where an external force is not applied may be shorter than a thickness along the z direction of each of the first electrode and the second electrode. When each of the displacement of the opposing interval between the two electrodes and the displacement of a relative position in the z direction between the two electrodes are same, a variation of the capacitance in a case where the predetermined opposing interval is shorter than a thickness of the electrodes is larger than the variation of the capacitance in a case where the thickness of the electrodes is shorter than the predetermined opposing interval. Thus, according to this configuration, the detection accuracy of the acceleration is improved.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. An acceleration sensor comprising:
a substrate having a main surface parallel to an x-y plane defined by an x direction and a y direction, the x direction being perpendicular to the y direction;
a first anchor and a second anchor, which are disposed above the main surface of the substrate;
a first weight portion supported by the first anchor;
a first electrode extending from the first weight portion;
a second electrode supported by the second anchor; and
a first beam connecting between the first weight portion and the first anchor,
wherein the first weight portion includes a first left portion and a first right portion, the first left portion having different weight from the first right portion, the first left portion and the first right portion being arranged along the x direction,
wherein the first beam includes a first connection beam and a first support beam,
wherein the first connection beam extends along the x direction between the first left portion and the first right portion,
wherein the first connection beam connects the first left portion with the first right portion,
wherein the first support beam extends along the y direction between the first connection beam and the first anchor,
wherein the first support beam connects and supports the first connection beam and the first anchor,
wherein the first electrode and the second electrode are opposed along the x direction,
wherein the first beam is configured that, when an acceleration is applied to the acceleration sensor in a z direction perpendicular to the x-y plane,
(i) the first left portion and the first right portion move in opposite directions each other in a z-x plane in a seesaw manner, in which the first anchor provides a support point, the z-x plane being defined by the z direction and the x direction,
(ii) an opposing area between the first electrode and the second electrode changes, and
(iii) an opposing interval between the first electrode and the second electrode changes.

2. The acceleration sensor according to claim 1, wherein
the first weight portion is linearly symmetrical with a reference line going through the first anchor,
the first beam is linearly symmetrical with the reference line going through the first anchor, and
the reference line is parallel with the x direction.

3. The acceleration sensor according to claim 1 further comprising:
a second weight portion; and
a second beam connecting the second weight portion with the second anchor,
wherein the second electrode extends from the second weight portion,
wherein the second weight portion has a second left portion and a second right portion, the second left portion having different weight from the second right portion, the second left portion and the second right portion being arranged along the x direction,
wherein the second beam includes a second connection beam and a second support beam,
wherein the second connection beam extends along the x direction between the second left portion and the second right portion,
wherein the second connection beam connects the second left portion with the second right portion,
wherein the second support beam extends along the y direction between the second connection beam and the second anchor,
wherein the second support beam connects and supports the second connection beam and the second anchor, and
wherein the second beam is configured that, when the acceleration is applied to the acceleration sensor in the z direction, the second left portion and the second right portion are movable in opposite directions each other in the z-x plane in the seesaw manner, in which the second anchor provides the support point.

4. The acceleration sensor according to claim 3, wherein
the second weight portion is linearly symmetrical with the reference line going through the first anchor,
the second beam is linearly symmetrical with the reference line going through the first anchor, and
the reference line is parallel with the x direction.

5. The acceleration sensor according to claim 3 4,
wherein the first weight portion and the second weight portion are arranged along the x direction, in which the first right portion is adjacent to the second left portion,
wherein the first electrode is provided in the first right portion, and the second electrode is provided in the second left portion, and
wherein the first left portion is heavier than the first right portion and the second left portion is heavier than the second right portion, or the first left portion is lighter than the first right portion and the second left portion is lighter than the second right portion.

6. The acceleration sensor according to claim 3,
wherein the second weight portion includes a second left weight portion and a second right weight portion,
wherein the second right portion of the second left weight portion and the first left portion of the first weight portion are adjacently arranged along the x direction,
wherein the second left portion of the second right weight portion and the first right portion of the first weight portion are adjacently arranged along the x direction,
wherein the second electrode is provided in the second right portion of the second left weight portion,
wherein the first electrode is provided in each of the first left portion and the first right portion,
wherein the second electrode is provided in the second left portion of the second right weight portion, and
wherein the second left portion of the second left weight portion is heavier than the second right portion of the second left weight portion, the first left portion is heavier than the first right portion, and the second left portion of the second right weight portion is heavier than the second right portion of the second right weight portion, or the second left portion of the second left weight portion is lighter than the second right portion of the second left weight portion, the first left portion is lighter than the first right portion, and the second left portion of the second right weight portion is lighter than the second right portion of the second right weight portion.

7. The acceleration sensor according to claim 1, wherein
when an external force is not applied to the acceleration sensor, an opposing interval along the x direction between the first electrode and the second electrode is shorter than a thickness along the z direction of each of the first electrode and the second electrode.
